(19) United States
(12) Patent Application Publication
(10) Pub. No.: US 2018/0370717 A1
(43) Pub. Date: Dec. 27, 2018

(54) METHOD FOR PRODUCING CONSUMER-READY VEGETABLES, MUSHROOMS OR HERBS IN A BOX

(71) Applicant: RIJK ZWAAN ZAADTEELT EN ZAADHANDEL B.V., De Lier (NL)

(72) Inventors: Wilhelmus Petrus Adrianus Roeland Voermans, De Lier (NL); Jeanette Diana Van Der Laken, De Lier (NL)

(21) Appl. No.: 16/029,851

(22) Filed: Jul. 9, 2018

Related U.S. Application Data
(63) Continuation-in-part of application No. PCT/EP2017/051249, filed on Jan. 20, 2017.

(30) Foreign Application Priority Data
Jan. 21, 2016 (NL) 2016129

(51) Int. Cl. B65D 85/52; A01G 9/029; A01G 22/15; A01G 18/64

(52) U.S. Cl. CPC B65D 85/52; A01G 9/0293; A01G 9/247; A01G 18/64; A01G 22/15

(57) ABSTRACT

The present invention relates to a method for producing consumer-ready vegetables, mushrooms or herbs, involving a) culturing vegetables, mushrooms or herbs in a closed container under suitable growing conditions until maturity; and b) transferring the container with the mature ve-getable, mushrooms or herb to a retail outlet, wherein the vegetables, mushrooms or herbs are cultured in a container with a plant compartment for containing the vegetables, mushrooms or herbs and a separate water compartment for containing water and nutrients, wherein one of the two compartments is provided with means for allowing water and nutrients to enter the plant compartment while preventing contaminations and pathogens from entering the said plant compartment. Preventing contaminations is achieved a filter that is permeable to water and nutrients but impermeable to contaminations and pathogens, such as viruses, bacteria, fungi, protists or insects, preferably in the bottom of the plant compartment.

### RELATED APPLICATIONS AND INCORPORATION BY REFERENCE

This application is a continuation-in-part application of international patent application Serial No. PCT/EP2017/051249 filed 20 Jan. 2017, which published as PCT Publication No. WO 2017/125588 on 27 Jul. 2017, which claims benefit of NL patent application Serial No. 2016129 filed 21 Jan. 2016.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to an improved method for producing consumer-ready vegetables, mushrooms or herbs. The invention also relates to a set that may comprise the constituents for performing the method and a container which may comprise the vegetable, mushrooms or herbs in any developmental stage.

### BACKGROUND OF THE INVENTION

Vegetables, mushrooms and herbs are traditionally produced by specialized growers in greenhouses or on fields. After harvest, the produce needs to be transported to a retail outlet. The transportation costs have an impact on the final consumer price. Moreover, it is sometimes necessary to store the produce before it is distributed. For certain products this may require specialized storage facilities.

WO2014/056869 relates to a new way of producing vegetables, herbs and mushrooms that leads to lower costs and a fresher product by way of a method for producing consumer-ready vegetables, mushrooms or herbs, which may comprise the steps of:

a) culturing vegetables, mushrooms or herbs in a closed container under suitable growing conditions until maturity; and

b) transferring the container with the mature vegetable, mushrooms or herb to a retail outlet.

It was now found that in this system the humidity in the closed container may become too high which could adversely affect the plant growth. Furthermore, there is a high risk of contamination of the growth medium by pathogens, especially when the growth medium may comprise nutrients which promote bacterial growth.

Citation or identification of any document in this application is not an admission that such document is available as prior art to the present invention.

### SUMMARY OF THE INVENTION

It is the object of the present invention to provide an improved method in which one or both of these problems are solved.

In the research leading to the invention it was found that when the plants are kept separated from the water and nutrients, contamination of the plants is avoided.

The invention thus relates to a method for producing consumer-ready vegetables, mushrooms or herbs, which may comprise the steps of:

a) culturing vegetables, mushrooms or herbs in a closed container under suitable growing conditions until maturity; and

b) transferring the container with the mature vegetable, mushrooms or herb to a retail outlet, characterized in that the vegetables, mushrooms or herbs are cultured in a container that may comprise a plant compartment for containing the vegetables, mushrooms or herbs and a second separate water compartment for containing water and nutrients, wherein one of the two compartment is provided with means for allowing water and nutrients to enter the plant compartment while preventing contaminations and pathogens from entering the said plant compartment.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 shows an exploded view of one embodiment of the container of the invention.

FIG. 2A shows a side view of the separate elements of the container.

FIG. 2B shows the container of FIG. 2A in use at the beginning of the growing process.

FIG. 2C shows the container of FIG. 2A with growing baby leaf plants.

FIG. 2D shows the container of FIG. 2A with mature lettuce heads.

FIG. 3 shows the consumer-ready containers.

FIG. 4A shows a second embodiment of the invention in the initial stage.

FIG. 4B shows the embodiment of FIG. 4A in the consumer-ready stage.

### DETAILED DESCRIPTION OF THE INVENTION

The invention thus relates to a method for producing consumer-ready vegetables, mushrooms or herbs, which may comprise the steps of:

a) culturing vegetables, mushrooms or herbs in a closed container under suitable growing conditions until maturity; and

b) transferring the container with the mature vegetable, mushrooms or herb to a retail outlet, characterized in that the vegetables, mushrooms or herbs are cultured in a container that may comprise a plant compartment for containing the vegetables, mushrooms or herbs and a second separate water compartment for containing water and nutrients, wherein one of the two compartment is provided with means for allowing water and nutrients to enter the plant compartment while preventing contaminations and pathogens from entering the said plant compartment.

The means for allowing water and nutrients to enter the plant compartment while avoiding that contaminations and pathogens enter the inner compartment are suitably formed by a filter. The filter is suitably integrated in the side of the container that is in contact with the water, usually the bottom.

The two compartments are separated from each other but are in liquid contact via the filter thus allowing the water compartment to provide water to the plant compartment for the growth of the plants, mushrooms or herbs. In particular embodiments, that will be described further below, one of the compartments is located within the other compartment.

In this respect, a filter can be made of any material that is permeable to water and nutrients but does obstruct the passing of bacteria, molds, yeast or any other micro-organism that could affect the growth of the vegetable, herb or mushroom present in the compartment. Such filters and filtration methods to sterilize liquids are known in the art. Several materials are known and used for the filtration include nylon, polycarbonate, cellulose acetate, polyvinylidene fluoride (PVDF), and polyethersulfone (PES). There are three important aspects in which these filter material might differ such as protein retention, flow rate and the presence of leachable materials. Another important aspect is the pore size that is applied in a filter. The pore size also relates to the type of micro-organism that should be kept out. For bacteria well known pore sizes are 0.22 and 0.45 μm.

In a preferred embodiment the plant compartment of the container further may comprise means for transporting water and nutrients entering the plant compartment to the vegetables, mushrooms and herbs. The means are suitably capillary means that distribute water and nutrients through the plant compartment to reach the seed or the roots of the growing plant. Such means are preferably formed by a carrier, in particular a mat. The mat may already comprise the seeds or the seeds are placed on or in the mat. The structure of the mat is suitable for transport and distribution of water and nutrients entering via the filter through the plant compartment via capillary action. The terms ‘mat’, ‘seed mat’ and ‘capillary mat’ are used interchangeably herein.

In this respect, a seed mat (also referred to as a seed cloth) is formed of any material that is suitable for growing plants from the seeds that are in the seed mat. Known materials that are used for such seed mats are fabric or paper or a combination thereof.

By avoiding direct contact between the water compartment and the plant compartment that initially may comprise the seed and after germination may comprise the plant, contamination of the seeds and plants with pathogens is avoided. One can make certain that the water with nutrients is pathogen-free before introducing it into the water compartment to avoid contamination but this is not necessary. Moreover, even if the water becomes contaminated the filter will keep the pathogens away from the plants.

The container is furthermore provided with a semipermeable foil for closing off the two compartments. This foil allows the exchange of gases and (water) vapor but keeps out pathogens and contaminants that may be present in the environment.

In one embodiment, the water and nutrients are in the space defined by the plant compartment and the water compartment, i.e. between the bottom of the plant compartment that may comprise the filter and the bottom of the water compartment, which is in this embodiment also the actual bottom of the container as a whole. It is of course also possible to culture the plants upside down and the bottom of the water container is then the top of the container as a whole but this is usually not preferred.

The roots of the plants take up water and nutrients through the transportation means, in particular the mat, that distributes the water and nutrients and provides it to the roots. The roots of the vegetables, mushrooms or herbs can thus grow on top of the mat, but also in the mat and through the mat.

In a further embodiment, the water compartment is formed by a bag which may comprise water and nutrients. The bag replaces the space defined by the bottoms of the plant and water compartments. The mat is suitably located on top of the bag and vegetables, mushrooms or herbs grow in or on the mat. In this embodiment the filter is located in the side of the bag that is in use in contact with the mat. This will usually be the upper side of the bag if the bag is located on the bottom of the plant compartment.

In another embodiment, the water compartment is made from a rigid material for proper handling. The plant compartment is suitably present in the form of a bag. The material used for such a bag is preferably not permeable for any compound. Said plant compartment in the form of a bag may comprise a seed mat and a filter. The filter is in contact with both the water compartment and the seed mat, thereby providing water and nutrients to the germinating seeds, mycelium or spores and/or growing vegetables, mushrooms or herbs.

The seeds are preferably sterile and integrated in the mat to avoid floating away. Alternatively, the seeds are fixed to the mat by means of an adhesive or a glue. The water and nutrients are suitably formed by standard hydroponics water. However, more specific recipes can be applied in order to optimally facilitate the growth of the vegetables, mushrooms or herbs, using the method of the invention.

Culturing of the vegetables, mushrooms or herbs until maturity takes suitably place in, or in the vicinity of, the retail outlet. Suitably the products are cultured in storage rooms or basements of the retail outlet. This way the transportation costs are saved. Moreover, the products need not be stored between harvest and transport to their point of sale and are therefore more fresh. The retail outlet is suitably a supermarket, but other types of stores can be envisaged as well.

It is not necessary for the method of the invention to be performed in the retail outlet itself. It is also possible that the products are grown in regional facilities to supply multiple retail outlets in the area, thus still having part of the benefit of lower transportation costs.

The growth facilities are preferably provided with specialized lighting systems designed to provide the correct light intensity and colour, in particular, well known assimilation lighting. Such systems may be automatically controlled to allow for a light and darkness cycle that is particularly adapted to the type of vegetable, mushroom or herb. Further, temperature as well humidity levels are preferably regulated carefully. Also the level of flow of air throughout the system is very relevant as well as the quality of the air that is applied. The air is preferably filtered in order to minimize the possibility of an infection.

Prior to culturing the vegetables, mushrooms or herbs, seed for the vegetable or herb or spores for the mushrooms is placed on the bottom of the plant compartment or on the bag, in particular on or in a capillary mat that is placed on the bottom of the plant compartment or on the bag that forms the water compartment. The two compartments form the container, which is then closed off. Alternatively, a germinated seed, seedling or plantlet of the vegetable or herb or mycelium for the mushrooms is used instead of seeds or spores.

In order to germinate, the seeds or spores need to be in contact with a fluid, such as water or a buffer. Suitably, closing the container is done after introducing the fluid into the water compartment of the container. Since the container remains unopened before the product is ready to be consumed, all nutrients and fluids needed to obtain a mature product are to be included in the container before closure thereof.

Suitably, the container is closed with a permeable membrane. The membrane is permeable to for example oxygen (O₂), carbon dioxide (CO₂) and water vapor but preferably impermeable to contaminations and pathogens, like viruses, bacteria, fungi, protists or insects. The products thus grow in a contamination- and pathogen-free environment. The resistance requirements for the products are much lower or even dispensable when compared to growing products in a greenhouse or on the field. Each plant or mushrooms is individually packed and cannot contaminate other plants or be contaminated. The retailer can thus use seeds that may comprise fewer resistances which as a consequence of the lower development costs is more cost-effective.

After sowing the seeds or spores, or planting the germinated seeds, seedlings, plantlets or mycelium, the container is closed with the membrane to be re-opened only by the consumer after the product is sold. Thus, the product itself does not require handling and remains much more hygienic.

In an embodiment, the seed mat is brought in contact with the water inside the growing container. By this action and through the capillary feature of the mat, germination of the seeds is triggered and seedlings will develop from the germinated seeds.

The method of the invention is particularly suitable for leafy vegetables, in particular, lettuce, endive, rucola, corn salad, chard, leaf beet, spinach, radish. The vegetables can also be sprout vegetables, such as cress, beet sprouts, alfalfa, broccoli sprouts, bean sprouts, fennel sprouts, cabbage sprouts, garlic sprouts, leek sprouts, pea sprouts, chickpea sprouts, radish sprouts.

The lettuce is for example, leaf lettuce, head lettuce or baby leaf lettuce. For baby leaf lettuce, different lettuce varieties can be used to obtain an attractive mixture. In one embodiment, two or more lettuce seeds of different varieties are used to obtain a mix of different leaf or head lettuce plants.

It will take about 4 to 5 weeks for leafy vegetables such as lettuce to grow to maturity. Since the lettuce is not harvested but sold in the container the shelf-life can be as long as 4 weeks. Preferably, the lettuce is consumed within three weeks from sale. The shelf-life of products grown by the method of the invention is influenced by multiple factors of which two are explicitly mentioned here. The temperature at which the mature product is stored is of relevance. Preferably, the container which may comprise the mature product is stored at a temperature between 0 and 10 degrees Celsius. More preferable, said container is stored at a temperature between 2 and 6 degrees Celsius. Another aspect which is of relevance is the presence of the semi-permeable foil on the container. In order to better regulate the moisture levels of the container which may comprise the mature product, the semi-permeable foil is preferably covered with a lid or a foil that is less permeable for gas exchange. However, to a certain extent gas exchange should still be possible if the original semi-permeable foil is covered.

The herbs are for example selected from chives, parsley, basil, dill, coriander, cilantro, mint, oregano, rosemary, thyme, marjoram, lemon balm, tarragon, sage. In a particular embodiment, mixtures of herbs can be produced such as an Italian herb mix or French herb mix.

Mixtures of mushrooms can also be made by using different spores. The method can also be used for obtaining one or a few large mushroom, such as a Portobello mushroom.

In a particular embodiment, the seeds can be provided in the form of a seed carrier, such as a seed mat, seed band or any other form. This is especially practical for mixtures of vegetables or herbs so that the correct seed distance is automatically obtained upon placing the seed carrier in the compartment.

The container suitably may comprise nutrients for the vegetables, mushrooms or herbs. For each type of product a suitable amount of nutrients can be added to the water.

The container is preferably provided with a label with information regarding the vegetable, mushrooms or herb. The information may comprise for example, the name of the vegetable, nutritional fact, best before date and the price. In addition to such sales information, other information, such as recipes, can be included as well. The container may also be provided with a paper wrap that contains such information.

The label or wrap can be applied prior to or immediately after closing the container. Preferably, the label or wrap is applied directly before transfer to the retail outlet. When applying the label or wrap, care should be taken that the upper side of the container is not so covered that entrance of light into the container is hampered.

The invention further relates to a set for producing consumer-ready vegetables, mushrooms or herbs, which may comprise a container, sowing or planting material, and a permeable membrane, wherein the container may comprise a plant compartment for containing the vegetables, mushrooms or herbs and a water compartment for containing water and nutrients, wherein one of the two compartment is provided with means for allowing water and nutrients to enter the plant compartment while preventing contaminations and pathogens from entering the plant compartment.

In a further embodiment, the water compartment is a bag provided with a filter and which may comprise the water and nutrients, which bag is inside the container and the vegetables, mushrooms or herbs grow in or on top of the bag, in particular in or on a capillary mat that is located on top of the bag. The filter allowing the water and nutrients contained in the bag to enter the mat is in contact with the mat and thus suitably located in the upper part of the bag. The advantage of using a pre-prepared bag is that the water with the nutrients can be produced and filled in the bag in a pathogen-free environment and requires no further handling that may involve contamination. The bag is suitably placed in a container. Suitably, the top of the container which may comprise the water compartment in the form of a bag is closed off with a semi-permeable foil as described herein.

In another embodiment, the water compartment is made from a rigid material for proper handling. The plant compartment is present in the form of a bag. The material used for such a bag should not be permeable for any compound and is made from a suitable film or foil. Said plant compartment in the form of a bag may comprise a seed mat and a filter. The filter is in contact with both the water compartment and the seed mat. The mat through its capillary capacity, provides water and nutrients to the developing seeds, mycelium or spores and/or growing vegetables, mushrooms or herbs. On the top side, the plant compartment is open or contains perforations through which the vegetables, mushrooms or herbs are able to develop and grow.

Both with respect to the method and the set, the size and form of the container preferably correspond with the size and form of the mature vegetable, or herb or the quantity of mushrooms to be produced. The container can also have any other form as well.

Suitably, the closing membrane is at least partially self-adhesive, in particular at the edges. Alternatively, the closing membrane is sealed to the container by means of a heat sealer. The membrane can then be easily stuck to the open side of the container to seal it off.

In one embodiment of the set, the seeds are already placed in the container, and the container is already closed with the membrane. In this embodiment no moisture should be present in the container because that might lead to premature germination. In order to introduce the fluid, the container is then provided with means to allow the fluid to enter the space between the plant compartment and the water compartment of the container. Such means are for example, valve means that avoid entrance of contaminants and pathogens.

The invention further relates to a container which may comprise a vegetable, mushrooms or herb, obtainable by the method as claimed. The container is suitably adapted to the form of the product. It can be a square box, a rectangular box or a tube, or any other form. In a particular embodiment, the container has a double bottom defining a space in between them to receive the water and nutrients needed for the plant to grow to maturity. In one embodiment, the double bottom is obtained by using two boxes, one of which is placed into the other and leaves a space between the bottom of the inner box and the bottom of the outer box. The inner box is then the plant compartment and the outer box is the water compartment.

The invention can be performed without the contribution of a grower. The retailer can buy his seed or the seed mat directly from seed companies. Since one step in the vegetable supply chain is now no longer necessary, the retailer can produce his own vegetables, mushrooms and herbs at a significantly lower cost.

The present invention are further illustrated in the figures. In the figures, like reference numerals refer to the same or corresponding parts.

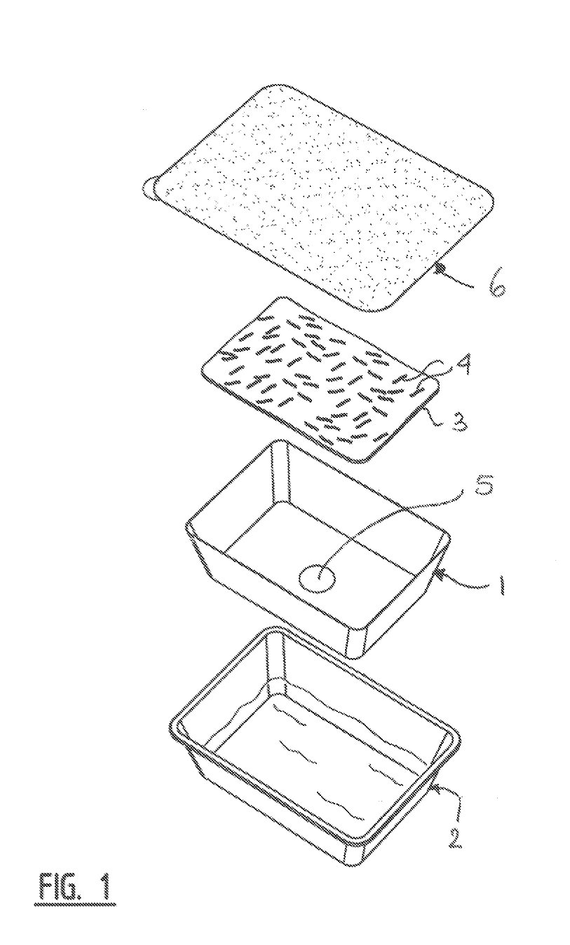

The embodiment shown in FIG. 1 may comprise a box 1 that forms the plant compartment and a larger box 2 that forms the water compartment. Furthermore, there is shown a mat 3 with seeds 4, which mat 3 fits in box 1. Box 1 has a filter 5 in its bottom. The membrane 6 is for sealing off the container formed by the two boxes. Box 2 is filled with water 7.

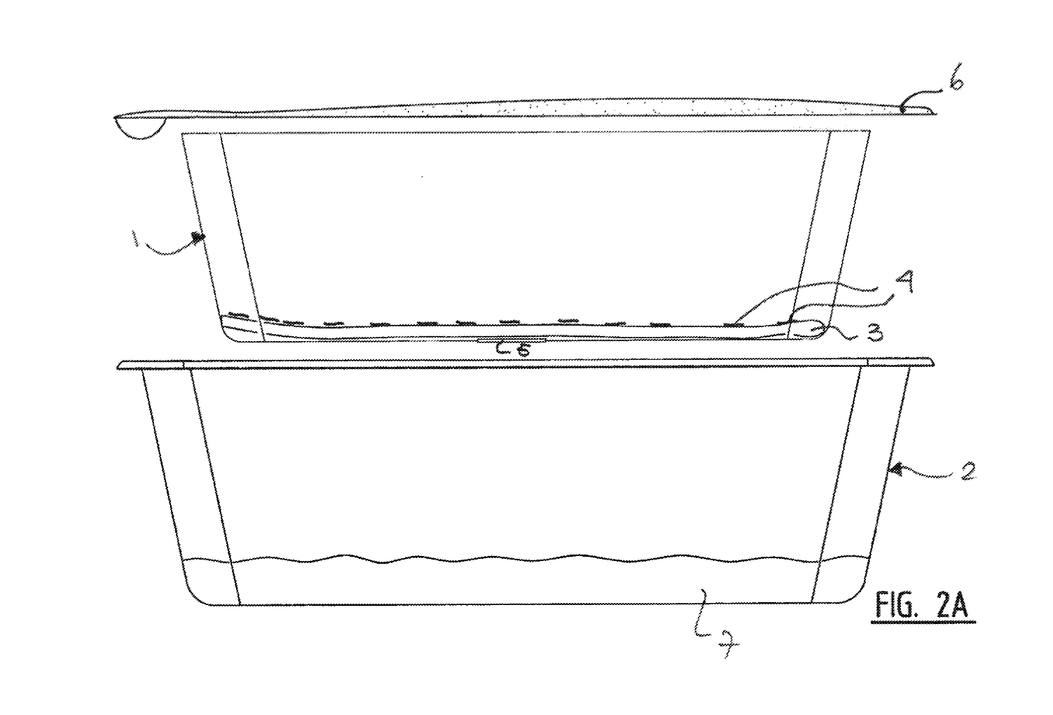

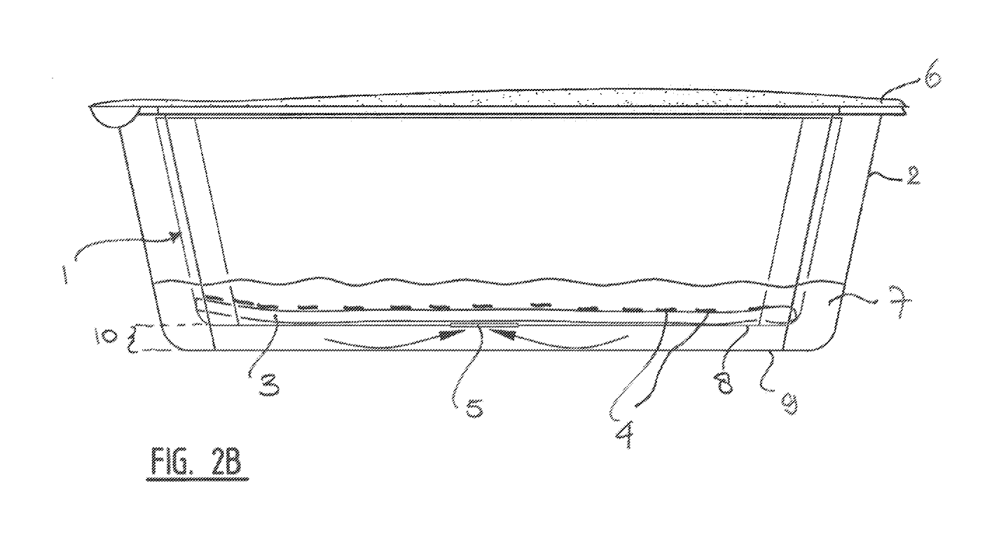

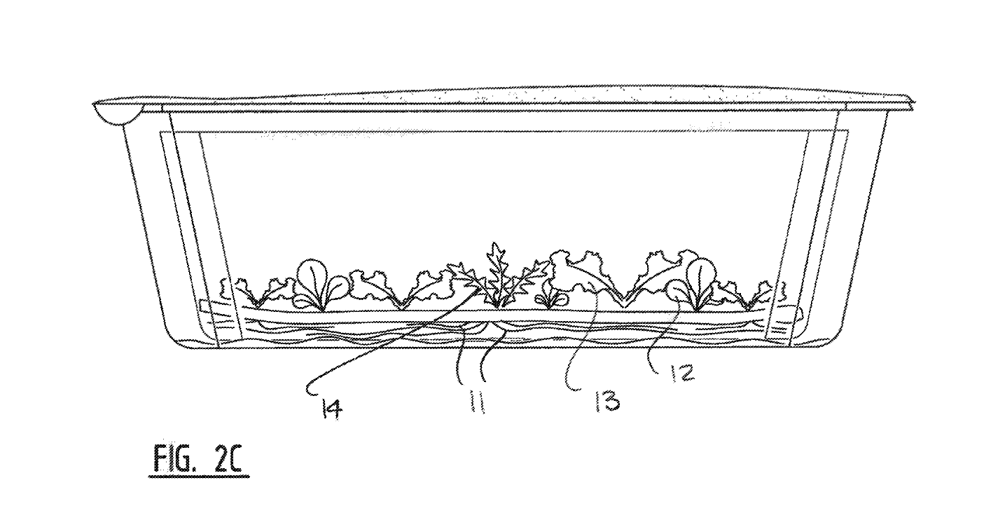

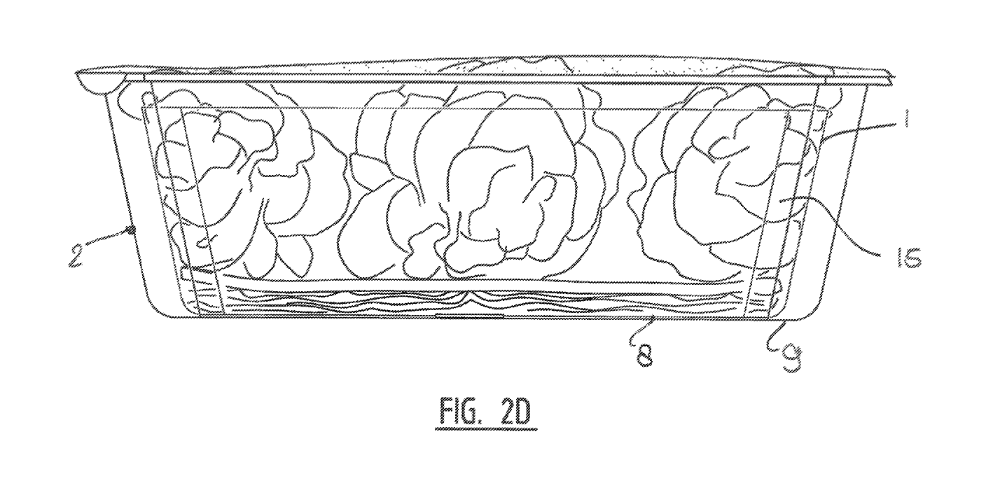

FIG. 2A shows the container of FIG. 1 from the side. FIG. 2B demonstrates that the two bottoms 8 and 9 of the boxes 1 and 2 leave a space 10 in between them. This space 10 contains the liquid medium 3 which may comprise water and nutrients. The bottom 8 of the inner box 1 which forms the plant compartment may comprise a filter 6 that allows water 3 to enter from the space 10 into box 1 but prevents microorganisms from passing from the water compartment to the plant but still allow the growing plant to take up nutrients. In this embodiment a seed mat 4 is envisaged. The seed mat has capillary action and facilitates uptake of nutrients and water. As shown in FIG. 2C, the roots 11 are capable of growing through the seed mat 5 but do not penetrate the bottom 8 of box 1. They therefore do not come into contact with the water and nutrients contained in the space 10.

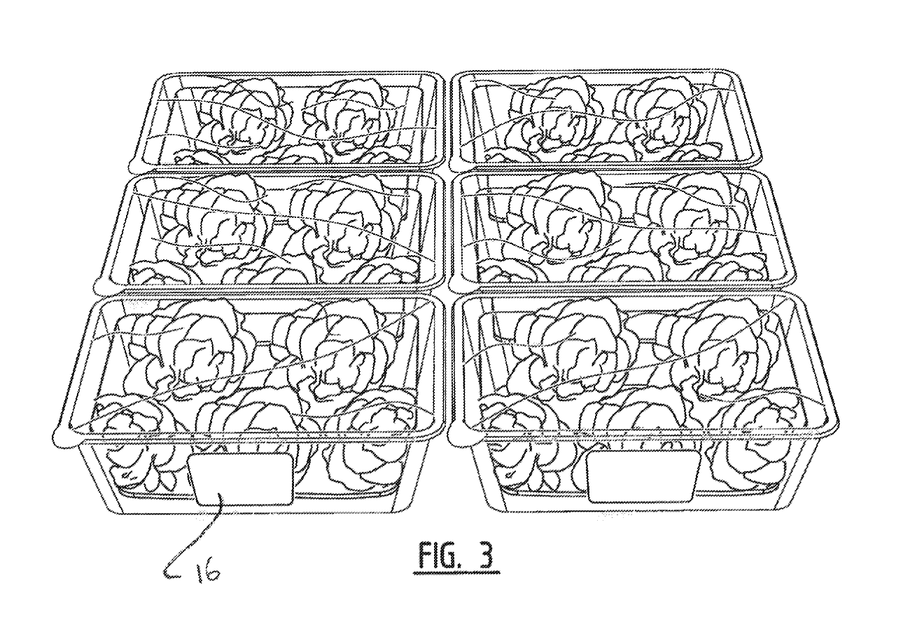

FIG. 2D shows the almost finished products with the mature vegetable plants 15. The water 3 has been totally consumed by the plants and the space 10 between the two bottoms 8 and 9 of boxes 1 and 2 has disappeared. In FIG. 3 it is shown that the boxes are provided with a label and are ready to be placed in a retail facility.

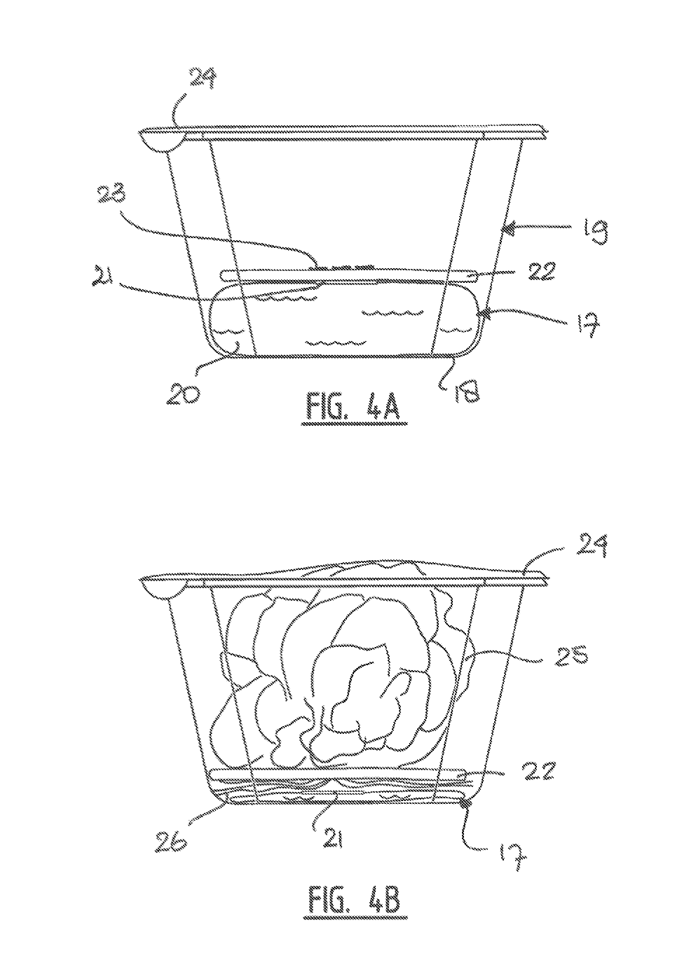

FIG. 4A shows another embodiment in which the water compartment is not the outer box but a bag 17 placed on the bottom 18 of the plant compartment 19 which is now the outer box. The bag 17 contains a liquid medium 20, i.e. water and nutrients, and is in its upper side provided with a filter 21 that only allows entrance of water and nutrients into plant compartment 15 but keeps out contaminants and pathogens that may be present in the liquid medium. A capillary mat 22 is placed on top of the bag 17. Seeds are placed on top of the mat or are integrated in the mat. The box that forms the plant compartment is sealed off with a permeable membrane 24 that allows gas exchange but is also impermeable to contaminants and pathogens.

In FIG. 4B the embodiment of FIG. 4A is shown in consumer-ready stage.

Although the present invention and its advantages have been described in detail, it should be understood that various changes, substitutions and alterations can be made herein without departing from the spirit and scope of the invention as defined in the appended claims.

The invention is further described by the following numbered paragraphs:

1. Method for producing consumer-ready vegetables, mushrooms or herbs, comprising the steps of:

a) culturing vegetables, mushrooms or herbs in a closed container under suitable growing conditions until maturity; and

b) transferring the container with the mature vegetable, mushrooms or herb to a retail outlet,

characterized in that the vegetables, mushrooms or herbs are cultured in a container that comprises a plant compartment for containing the vegetables, mushrooms or herbs and a separate water compartment for containing water and nutrients, wherein one of the two compartments is provided with means for allowing water and nutrients to enter the plant compartment while preventing contaminations and pathogens from entering the said plant compartment.

2. Method of paragraph 1, wherein the plant compartment is located inside the water compartment, and wherein the bottom of the plant compartment comprises a filter that is permeable to water and nutrients but impermeable to contaminations and pathogens, such as viruses, bacteria, fungi, protists or insects.

3. Method of paragraph 2, wherein the plant compartment comprises means for transporting water and nutrients entering the plant compartment to the vegetables, mushrooms or herbs.

4. Method of paragraph 2, wherein the means for transporting water are capillary means, such as a mat.

5. Method of paragraph 2, 3 or 4, wherein the plant compartment floats on water contained in the water compartment.

6. Method of any one of the paragraphs 2-5, wherein the water and nutrients are comprised in the space between the bottoms of the plant and water compartment.

7. Method of paragraph 1, wherein the water compartment has the form of a bag, which is provided with a filter that is permeable to water and nutrients but impermeable to contaminations and pathogens, such as viruses, bacteria, fungi, protists or insects and the bag is located inside the plant compartment.

8. Method as paragraphed 7, wherein the vegetables, mushrooms or herbs grow on a mat that is in contact with the filter.

9. Method of paragraph 1, wherein the plant compartment has the form of a bag, which is provided with a filter that is permeable to water and nutrients but impermeable to contaminations and pathogens, such as viruses, bacteria, fungi, protists or insects and the bag is located inside the water compartment.

10. Method as paragraphed 9, wherein the vegetables, mushrooms or herbs grow on a mat that is in contact with the filter.

11. Method of any one of the paragraphs 1-10, wherein the container is closed off with a permeable membrane, which is preferably permeable to oxygen (O₂), carbon dioxide (CO₂) and water vapor but preferably impermeable to contaminations and pathogens, such as viruses, bacteria, fungi, protists or insects.

12. Method of any one of the paragraphs 1-11, wherein prior to culturing the vegetables, mushrooms or herbs, a seed, germinated seed, seedling or small plant for the vegetable or herb or mycelium for the mushrooms is placed in the plant compartment and the container is closed.

13. Method of any one of the paragraphs 1-12, wherein the vegetables are leafy vegetables, in particular lettuce, in particular leaf lettuce, head lettuce or baby leaf lettuce, endive, rucola, lamb lettuce, corn salad, chard, leaf beet, spinach, radish, sprout vegetables, in particular, cress, beet sprouts, alfalfa, broccoli sprouts, bean sprouts, fennel sprouts, cabbage sprouts, garlic sprouts, leek sprouts, pea sprouts, chickpea sprouts, or wherein the herbs are selected from chives, parsley, basil, dill weed, coriander, cilantro, mint, oregano, rosemary, thyme, marjoram, lemon balm.

14. Method of any one of the paragraphs 1-13, wherein the seeds are provided in the form of a seed mat or seed band.

15. Method of any one of the paragraphs 1-14, wherein the container is provided with a label with information regarding the vegetable, mushrooms or herb.

16. Method of any one of the paragraphs 1-15, wherein culturing of the vegetables, mushrooms or herbs until maturity takes place in or in the vicinity of the retail outlet.

17. Set for producing consumer-ready vegetables, mushrooms or herbs, comprising a container, sowing or planting material and a permeable membrane, wherein the container comprises a plant compartment for containing the vegetables, mushrooms or herbs and a water compartment for containing water and nutrients, wherein one of the two compartment is provided with means for allowing water and nutrients to enter the plant compartment while preventing contaminations and pathogens from entering the plant compartment.

18. Set of paragraph 17, wherein the plant compartment is configured such that it fits inside the water compartment while leaving a space for the water and nutrients in between the bottoms of the first and second compartment.

19. Set of paragraph 17, wherein the water compartment has the form of a bag that fits inside the plant compartment while leaving sufficient room in the first compartment for the vegetables, mushrooms or herbs to grow to their ready-to-harvest stage.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for producing consumer-ready vegetables, mushrooms or herbs, comprising the steps of:
a) culturing vegetables, mushrooms or herbs in a closed container under suitable growing conditions until maturity; and
b) transferring the container with the mature vegetable, mushrooms or herb to a retail outlet,
characterized in that the vegetables, mushrooms or herbs are cultured in a container that comprises a plant compartment for containing the vegetables, mushrooms or herbs and a separate water compartment for containing water and nutrients, wherein one of the two compartments is provided with means for allowing water and nutrients to enter the plant compartment while preventing contaminations and pathogens from entering the said plant compartment.

2. The method as claimed in claim 1, wherein the plant compartment is located inside the water compartment, and wherein the bottom of the plant compartment comprises a filter that is permeable to water and nutrients but impermeable to contaminations and pathogens, such as viruses, bacteria, fungi, protists or insects.

3. The method as claimed in claim 2, wherein the plant compartment comprises means for transporting water and nutrients entering the plant compartment to the vegetables, mushrooms or herbs.

4. The method as claimed in claim 2, wherein the means for transporting water are capillary means, such as a mat.

5. The method as claimed in claim 2, wherein the plant compartment floats on water contained in the water compartment.

6. The method as claimed in claim 2, wherein the water and nutrients are comprised in the space between the bottoms of the plant and water compartment.

7. The method as claimed in claim 1, wherein the water compartment has the form of a bag, which is provided with a filter that is permeable to water and nutrients but impermeable to contaminations and pathogens, such as viruses, bacteria, fungi, protists or insects and the bag is located inside the plant compartment.

8. The method as claimed 7, wherein the vegetables, mushrooms or herbs grow on a mat that is in contact with the filter.

9. The method as claimed in claim 1, wherein the plant compartment has the form of a bag, which is provided with a filter that is permeable to water and nutrients but impermeable to contaminations and pathogens, such as viruses, bacteria, fungi, protists or insects and the bag is located inside the water compartment.

10. The method as claimed 9, wherein the vegetables, mushrooms or herbs grow on a mat that is in contact with the filter.

11. The method as claimed in claim 1, wherein the container is closed off with a permeable membrane, which is preferably permeable to oxygen (O₂), carbon dioxide (CO₂) and water vapor but preferably impermeable to contaminations and pathogens, such as viruses, bacteria, fungi, protists or insects.

12. The method as claimed in claim 1, wherein prior to culturing the vegetables, mushrooms or herbs, a seed, germinated seed, seedling or small plant for the vegetable or herb or mycelium for the mushrooms is placed in the plant compartment and the container is closed.

13. The method as claimed in claim 1, wherein the vegetables are leafy vegetables or sprout vegetables.

14. The method as claimed in claim 13, wherein the leafy vegetables are lettuce (in particular leaf lettuce, head lettuce or baby leaf lettuce), endive, rucola, lamb lettuce, corn salad, chard, leaf beet, spinach, or radish or the sprout vegetables are cress, beet sprouts, alfalfa, broccoli sprouts, bean sprouts, fennel sprouts, cabbage sprouts, garlic sprouts, leek sprouts, pea sprouts, chickpea sprouts.

15. The method as claimed in claim 1, wherein the herbs are chives, parsley, basil, dill weed, coriander, cilantro, mint, oregano, rosemary, thyme, marjoram, or lemon balm.

16. The method as claimed in claim 1, wherein the seeds are provided in the form of a seed mat or seed band.

17. The method as claimed in claim 1, wherein the container is provided with a label with information regarding the vegetable, mushrooms or herb.

18. The method as claimed in claim 1, wherein culturing of the vegetables, mushrooms or herbs until maturity takes place in or in the vicinity of the retail outlet.

19. A set for producing consumer-ready vegetables, mushrooms or herbs, comprising a container, sowing or planting material and a permeable membrane, wherein the container comprises a plant compartment for containing the vegetables, mushrooms or herbs and a water compartment for containing water and nutrients, wherein one of the two compartment is provided with means for allowing water and nutrients to enter the plant compartment while preventing contaminations and pathogens from entering the plant compartment.

20. The set as claimed in claim 19, wherein the plant compartment is configured such that it fits inside the water compartment while leaving a space for the water and nutrients in between the bottoms of the first and second compartment.

21. The set as claimed in claim 19, wherein the water compartment has the form of a bag that fits inside the plant compartment while leaving sufficient room in the first compartment for the vegetables, mushrooms or herbs to grow to their ready-to-harvest stage.
